(19) United States
(12) Patent Application Publication
(10) Pub. No.: US 2023/0082885 A1
(43) Pub. Date: Mar. 16, 2023

(54) FISHING ROD HANDLE MEMBER AND FISHING ROD

(71) Applicant: GLOBERIDE, Inc., Tokyo (JP)

(72) Inventor: Takuji KAWAMURA, Tokyo (JP)

(21) Appl. No.: 17/940,252

(22) Filed: Sep. 8, 2022

(30) Foreign Application Priority Data
Sep. 10, 2021 (JP) 2021-147436
Sep. 10, 2021 (JP) 2021147436

(51) Int. Cl. A01K 87/08; A01K 87/04

(52) U.S. Cl. CPC A01K 87/08; A01K 87/04

(57) ABSTRACT

A fishing rod handle member according to one embodiment of the present disclosure includes: a reel seat main body having a bulging portion (trigger) and a reel leg placement portion on which a reel leg is placed; and a grip provided rearward of the reel seat main body when viewed in an axial direction of the reel seat main body, wherein the reel seat main body has a grip portion in a range from 40 mm frontward of the bulging portion (trigger) to 100 mm rearward when viewed in the axial direction, and a first portion occupying at least 10° of an upper half portion of the grip portion has (or is configured to have) a flat surface or a curved surface whose curvature radius is larger than that of a second portion other than the first portion when viewed in a circumferential direction of the reel seat main body.

### CROSS-REFERENCE TO RELATED APPLICATIONS

This application claims priority under 35 U.S.C. § 119 to Japanese Patent Application No. 2021-147436 filed on Sep. 10, 2021, in the Japanese Patent Office, the entire contents of which is hereby incorporated by reference.

### FIELD

The present disclosure relates to a fishing rod handle member having a fishing rod reel seat portion, and a fishing rod including the fishing rod handle member.

### BACKGROUND

Conventionally, various fishing rods including a fishing rod reel seat and a grip have been known.

In such a fishing rod, a fishing rod reel seat and a fishing rod grip are usually placed on a rod body, and a reel leg placement portion for placing a reel leg is formed on an upper or lower side of a main body of the fishing rod reel seat.

As such a fishing rod, for example, JP H11-137132 A discloses a fishing rod including a rod body, a cylindrical reinforcing resin layer provided on a peripheral surface of the rod body and having an uneven surface formed on an outer periphery, and a reel seat injection-molded on an outer peripheral surface of the reinforcing resin layer.

In addition, JP 2013-21923 A discloses a fishing rod including a rear grip portion on a rear side of a reel seat including a cylindrical reel seat main body having a reel leg placement portion on which a leg portion of a reel is placed, the fishing rod including: a rod main body; and a rear grip rod body in which the rear grip portion is integrally formed by increasing a diameter of the rear portion at a diameter change rate larger than the diameter change rate of the rod main body during the formation of the hollow rod body from a prepreg, wherein a rear portion of the rod main body and a front portion of the rear grip rod body are overlapped inward and outward so as to form an overlapping portion having a predetermined length and joined integrally with each other, and at least a part of the overlapping portion is located on an inner side of the reel seat main body.

### SUMMARY

However, in the fishing rod disclosed in JP H11-137132 A, the weight increases because the cylindrical reinforcing resin layer on the rod body and the solid reel seat injection-molded on the outer peripheral surface of the cylindrical reinforcing resin layer are provided; in addition, the thick reel seat functions as a cushioning material, which not only significantly reduces the sensitivity of the fishing rod, but also poses a problem that the grip property is not considered at all.

In the fishing rod disclosed in JP 2013-21923 A, since the rear grip rod body and the reel seat main body are joined to the rod main body, the weight unavoidably increases due to bonding, and the bonding portion and a plurality of layers are interposed and function as a cushioning material, which not only significantly reduces the sensitivity of the fishing rod, but also poses a problem that the grip property is not considered at all.

The present disclosure has been made in view of the above circumstances, and an object of the present disclosure is to provide a fishing rod handle member in which a reel seat main body and a grip constituting the handle member are individually formed in desired shapes and that includes a fishing rod reel seat that significantly improves the grip property during gripping of the reel seat main body, and a fishing rod including the fishing rod handle member. Other objects of the present disclosure will become apparent by reference to the entire specification.

A fishing rod handle member according to one embodiment of the present disclosure includes: a reel seat main body having a bulging portion (trigger) and a reel leg placement portion on which a reel leg is placed; and a grip provided rearward of the reel seat main body when viewed in an axial direction of the reel seat main body, wherein the reel seat main body has a grip portion in a range from 40 mm frontward of the bulging portion (trigger) to 100 mm rearward when viewed in the axial direction, and a first portion occupying at least 10° of an upper half portion of the grip portion has (or is configured to have) a flat surface or a curved surface whose curvature radius is larger than that of the rest of the portion (a second portion) other than the first portion when viewed in a circumferential direction of the reel seat main body.

In the fishing rod handle member according to one embodiment of the present disclosure, the reel seat main body and the grip are separately formed. In the fishing rod handle member according to one embodiment of the present disclosure, at least one of the reel seat body and the grip is partially or entirely formed of carbon fiber reinforced plastic.

A fishing rod handle member according to one embodiment of the present disclosure is configured such that the curvature radius of the curved surface of the first portion occupying at least 10° of an upper half portion of the grip portion is R20 or more or −R30 or less. In addition, the fishing rod handle member according to one embodiment of the present disclosure is configured such that the curvature radius of the curved surface of the second portion is R13 or more and less than R20.

A fishing rod handle member according to one embodiment of the present disclosure is configured so as to include a transition portion between the first portion on the upper half portion of the grip portion and the second portion. In addition, in the fishing rod handle member according to one embodiment of the present disclosure, the transition portion is an inflection line or an inflection surface, and when the transition portion is an inflection surface, the surface is flat or has a curvature radius in a range of R0.1 to R1.0.

In the fishing rod handle member according to one embodiment of the present disclosure, the grip includes a grip portion in a range of 100 mm from a rear end when viewed in the axial direction, and a first portion occupying at least 10° of the upper half portion of the grip portion has (or is configured to have) a flat surface or a curved surface whose curvature radius is larger than that of the rest of the portion (a second portion) other than the first portion when viewed in the circumferential direction of the grip.

In the fishing rod handle member according to one embodiment of the present disclosure, the fishing rod handle is formed in a hollow shape.

The fishing rod handle member according to one embodiment of the present disclosure is configured such that an end of the rod body is attached to one end of the reel seat main body on an opposite side of the grip.

A fishing rod according to one embodiment of the present disclosure includes any one of the above fishing rod handle members and the rod body.

According to the embodiment above, it is possible to provide the fishing rod handle member in which the reel seat main body and the grip constituting the handle member are individually formed in desired shapes and that includes the fishing rod reel seat that significantly improves the grip property during gripping of the reel seat main body, and the fishing rod including the fishing rod handle member.

### BRIEF DESCRIPTION OF THE DRAWINGS

FIG. 1 is a view illustrating a fishing rod according to one embodiment of the present disclosure;

FIG. 2 is a view illustrating a fishing rod reel seat according to one embodiment of the present disclosure;

FIG. 3 is a view illustrating a fishing rod handle member according to one embodiment of the present disclosure;

FIG. 4A is a view illustrating the fishing rod handle member according to one embodiment of the present disclosure, and FIG. 4B is a view illustrating a cross section of the fishing rod handle member according to one embodiment of the present disclosure;

FIG. 5A is a view illustrating a cross section of the fishing rod handle member according to one embodiment of the present disclosure, and FIG. 5B is a partially enlarged view illustrating a cross section of the fishing rod handle member according to one embodiment of the present disclosure;

FIG. 6 is a view illustrating a cross section of the fishing rod handle member according to one embodiment of the present disclosure;

FIG. 7 is a view illustrating a cross section of the fishing rod handle member according to one embodiment of the present disclosure;

FIGS. 8A to 8H are a view illustrating a method of molding the reel seat main body of the fishing rod handle member according to one embodiment of the present disclosure;

FIGS. 9A to 9G are a view illustrating a method of molding the grip of the fishing rod handle member according to one embodiment of the present disclosure;

FIGS. 10A to 10D are a view illustrating the fishing rod handle member according to one embodiment of the present disclosure;

FIGS. 11A and 11B are a view illustrating a cross section of the fishing rod handle member according to one embodiment of the present disclosure; and

FIG. 12 is a view illustrating the fishing rod handle member according to one embodiment of the present disclosure.

### DETAILED DESCRIPTION

Hereinafter, an embodiment of a fishing rod according to the present disclosure will be specifically described with reference to the accompanying drawings. Components common to a plurality of drawings are denoted by the same reference numerals throughout the plurality of drawings. It should be noted that the drawings are not necessarily drawn to scale for convenience of description.

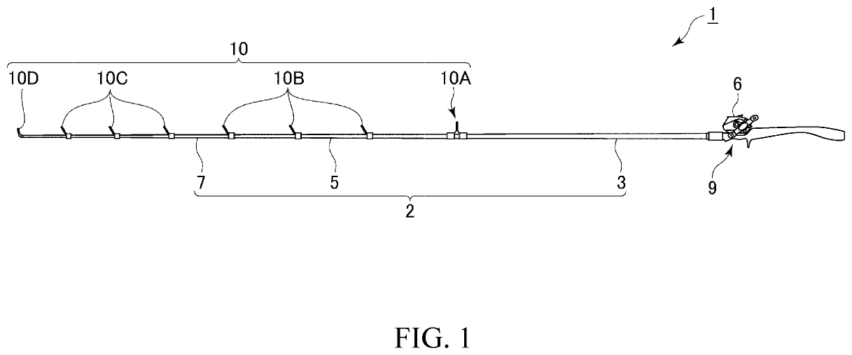

FIG. 1 is a view illustrating a fishing rod according to one embodiment of the present disclosure. As illustrated in the drawing, a fishing rod 1 according to one embodiment of the present disclosure includes a rod body 2, a reel R attached to the rod body 2 via a reel seat 9, and a fishing line guide 10 attached to the rod body 2. In the illustrated embodiment, the reel seat 9 and each of the fishing line guides 10 correspond to attachment components attached to an outer peripheral surface of the rod body.

The rod body 2 is configured by, for example, connecting a base rod 3, a middle rod 5, a tip rod 7, and the like. Each of these rod bodies is joined together, for example, in an ordinarily jointed type. The base rod 3, the middle rod 5, and the tip rod 7 may be joined together in a telescopic type, an inversely jointed type, a socket-and-spigot jointed type, or any other known joining style. The rod body 2 may be formed of a single rod body.

The base rod 3, the middle rod 5, and the tip rod 7 are formed into, for example, a tubular body made of fiber-reinforced resin. The tubular body made of fiber-reinforced resin is fabricated by winding a fiber-reinforced resin prepreg (prepreg sheet) including reinforcing fibers impregnated with matrix resin around a mandrel, and heating and curing the prepreg sheet. As the reinforcing fibers contained in the prepreg sheet, for example, carbon fibers, glass fibers, and any other known reinforcing fibers can be used. As the matrix resin contained in the prepreg sheet, thermosetting resins such as epoxy resin can be used. After the prepreg sheet is cured, the mandrel is removed. The outer surface of the tubular body is polished as appropriate. Each of the rod bodies may be formed in a solid state.

In the illustrated embodiment, the base rod 3, the middle rod 5, and the tip rod 7 are provided with a plurality of fishing line guides 10 (fishing line guides 10A to 10D) for guiding a fishing line reeled out from the reel 6 attached to the reel seat 9. More specifically, the base rod 3 is provided with a fishing line guide 10A, the middle rod 5 is provided with a fishing line guide 10B, and the tip rod 7 is provided with a fishing line guide 10C. A top guide 10D is provided at the tip of the tip rod 7, but details are omitted.

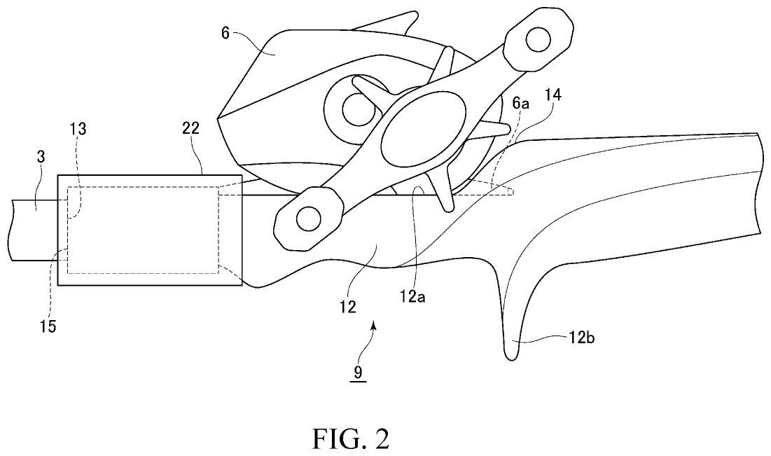

Next, a basic configuration of a reel seat main body 12 and the reel seat 9 will be described with reference to FIG. 2. The reel seat 9 includes the reel seat main body 12 having, along its axial direction, a reel leg placement surface 12a on which a reel leg 6a of the fishing reel 6 is placed. The reel seat main body 12 is formed in a cylindrical shape as a whole. The reel seat main body 12 can be configured to have a length of 100-200 mm, for example, but the configuration is not limited thereto.

In addition, the reel seat main body 12 includes a bulging portion (trigger) 12b that is a slightly bulged portion from the opposite side of the reel leg placement surface 12a and has an easy-to-grip curved outer surface that supports a thenar and an area near the thenar when gripped with a gripping hand.

The reel leg placement surface 12a of the reel seat main body 12 can be formed flat or substantially flat with a curvature larger than that of other circumferential portions (for example, the grip portion 12b) of the reel seat main body 12 adjacent to the reel leg placement surface 12a, and is formed so as to extend in the axial direction of the reel seat main body 12 illustrated in FIG. 2. A fixed hood 14 is integrally disposed at one end (rod base side) of the reel seat main body 12. One end of the reel leg placement surface 12a of the reel seat main body 12 is disposed inside the fixed hood 14.

A moving hood 22 is attached to the other end (rod tip side) of the reel seat main body 12 so as to be movable in the axial direction. The reel seat main body 12 and the moving hood 22 may be collectively referred to as the reel seat 9, but details are omitted.

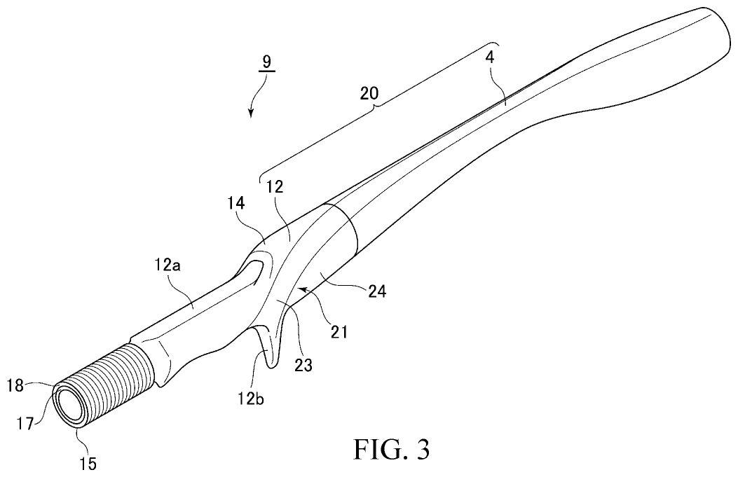

Next, a fishing rod handle member 20 according to one embodiment of the present disclosure will be described with reference to FIG. 3 (and FIG. 2). Here, the fishing rod handle member 20 includes the reel seat main body 12 described above and a grip 4 formed adjacent to the reel seat main body 12, but a connection member may be provided between them as necessary. Although the reel seat 9 and the grip 4 described above can also be collectively referred to as the fishing rod handle member 20, description will be given as above in the present embodiment.

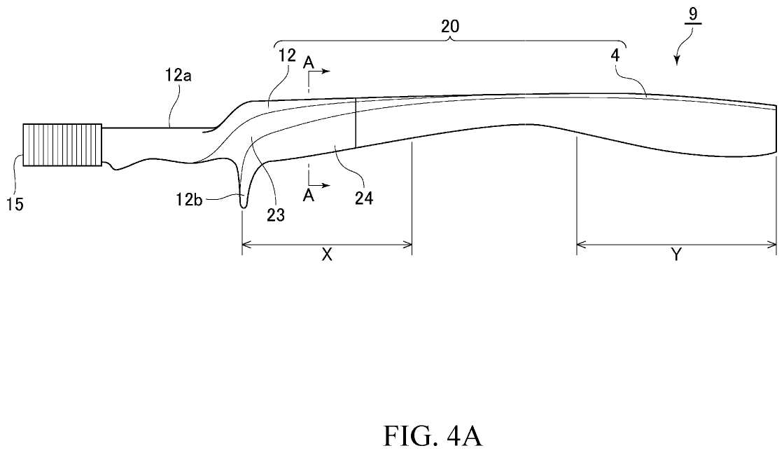

As illustrated in the drawing, in the fishing rod handle member 20 according to one embodiment of the present disclosure, the reel seat main body 12 having the reel leg placement portion 12a on which the reel leg 6b is placed is separately formed from the grip 4. Forming these two components separately in this manner is advantageous in that the materials can be selected as appropriate and the shape variation can be easily extended. The reel seat main body 12 and the grip 4 can be joined to each other by bonding, press-fitting (fitting), or screwing, but the joining method is not limited thereto. In the fishing rod handle member according to one embodiment of the present disclosure, at least one of the reel seat body and the grip is partially or entirely formed of carbon fiber reinforced plastic. Thus, cost reduction is possible by adopting an appropriate material or manufacturing method while maintaining necessary functions. In addition, as illustrated in FIG. 4B described later, the fishing rod handle member 20 according to one embodiment of the present disclosure can be formed in a hollow shape. Thus, it is possible to significantly reduce the weight without affecting the sensitivity given to the fishing rod.

In the fishing rod handle member 20 according to one embodiment of the present disclosure, at least one of the reel seat body and the grip can be entirely or partially formed of carbon fiber reinforced plastic (CFRP). At least one of the reel seat main body and the grip may be entirely or partially formed of CFRTP (continuous fiber), CFRTP (discontinuous fiber), or a hybrid. By being formed of such a material, it is possible to suppress an increase in weight while securing sufficient rigidity and strength of the handle member 20 used for a fishing rod.

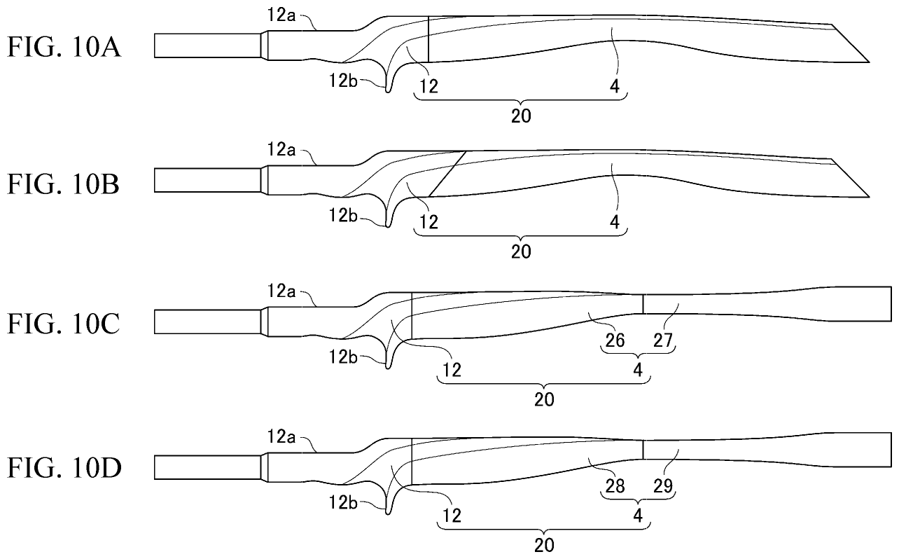

Next, in the fishing rod handle member 20 according to one embodiment of the present disclosure, description will be given with reference to FIGS. 10A to 10D about aspects of the case where the reel seat main body 12 having the reel leg placement portion 12a on which the reel leg 6b is placed is separately formed from the grip 4.

First, in the example illustrated in FIG. 10A, the reel seat main body 12 is formed of resin material, and has an end (an end portion in the right direction of the paper surface) 27 mm rearward of the bulging portion (trigger) 12b when viewed in the axial direction of the reel seat main body (in the right direction of the paper surface), and the grip 4 is connected to the end and is formed of fiber-reinforced plastic (FRP) material. One or a plurality of connection members (not illustrated) may be provided between the reel seat main body 12 and the grip 4. The material of the one or more connection members can be configured similarly to the reel seat main body 12 or the grip 4 (the same applies hereinafter). Similarly in the example illustrated in FIG. 10B, the reel seat main body 12 is formed of resin material, and has a center point of an inclined end (an end portion in the right direction of the paper surface) 27 mm rearward of the bulging portion (trigger) 12b when viewed in the axial direction of the reel seat main body (in the right direction of the paper surface), and the grip 4 is connected to the end and is formed of fiber-reinforced plastic (FRP) material. One or a plurality of connection members (not illustrated) may be provided between the reel seat main body 12 and the grip 4.

In the example illustrated in FIG. 10C, the reel seat main body 12 is formed of fiber-reinforced plastic (FRP) material, and has an end (an end portion in the right direction of the paper surface) 13 mm rearward of the bulging portion (trigger) 12b when viewed in the axial direction of the reel seat main body (in the right direction of the paper surface), and the grip 4 is connected to the end and is formed of a front portion 26 and a rear portion 27, with the front portion 26 made of fiber-reinforced plastic (FRP) material and the rear portion made of resin material. One or a plurality of connection members (not illustrated) may be further provided between the front portion 26 and the rear portion 27. In the example illustrated in FIG. 10D, the reel seat main body 12 is formed of resin material, and has an end (an end portion in the right direction of the paper surface) 13 mm rearward of the bulging portion (trigger) 12b when viewed in the axial direction of the reel seat main body (in the right direction of the paper surface), and the grip 4 is connected to the end and includes a front portion 28 and a rear portion 29, with both the front portion 28 and the rear portion 29 formed of fiber-reinforced plastic (FRP) material. One or a plurality of connection members (not illustrated) may be further provided between the front portion 28 and the rear portion 29. Here, shapes, structures, materials, and dimensions of the reel seat main body 12 and the grip 4 can be variously considered and are not intended to be limited to specific aspects.

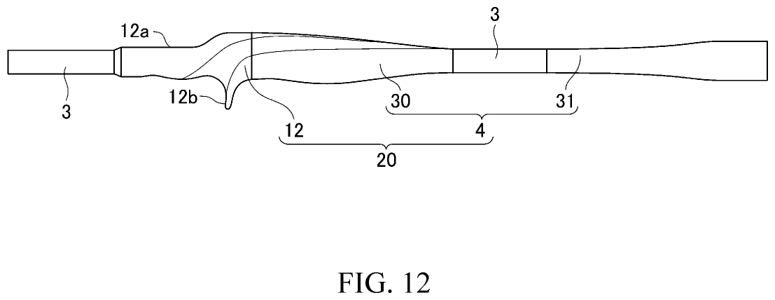

Next, in the fishing rod handle member 20 according to one embodiment of the present disclosure, description will be given with reference to FIG. 12 about another aspect of the case where the reel seat main body 12 having the reel leg placement portion 12a on which the reel leg 6b is placed is separately formed from the grip 4.

In the example illustrated in FIG. 12, the reel seat main body 12 is formed of resin material, and has an end (an end portion in the right direction of the paper surface) 13 mm rearward of the bulging portion (trigger) 12b when viewed in the axial direction of the reel seat main body (in the right direction of the paper surface), and a front portion 30 of the grip 4 is connected to the end and a rear portion 31 is connected to the front portion 30 via a connection portion. The grip 4 is formed of, for example, fiber reinforced plastic (FRP) material. The materials of the reel seat main body 12 and the grip 4 are not limited to resin material or fiber-reinforced plastic (FRP). In addition, the front portion 30 and the rear portion 31 may be formed of the same or different materials. Furthermore, if the reel seat main body 12 and the front portion 30 are formed of the same material, they may be integrally molded. In the example illustrated in FIG. 12, the above connection portion is the rod body (base rod) 3. That is, in the example illustrated in FIG. 12, the above-described rod body (base rod) 3 is formed so as to pass through the reel seat main body 12 and the front portion 30 of the grip 4 (that is, these members are formed in a hollow shape) from the left side of the paper surface, to be exposed from the right side end of the front portion 30 on the paper surface, and to be inserted into the rear portion 31 of the grip 4 (that is, the rear portion 31 is at least partially formed in a hollow shape). Thus, it is possible to freely set the distance between the front portion and the rear portion, select different materials, as appropriate, for the front portion and the rear portion, and make each portion size smaller than when integrally molded and make molding easier (the same applies throughout the present specification).

Next, the fishing rod handle member 20 according to one embodiment of the present disclosure will be described with reference to FIGS. 4A and 4B. As illustrated in the drawing, the fishing rod handle member 20 according to one embodiment of the present disclosure includes: the reel seat main body 12 having the reel leg placement portion 12a on which the reel leg 6b is placed; and the grip 4 connected to the reel seat main body 12, wherein the reel seat main body has a grip portion 21 in a range (X) from 40 mm frontward of the bulging portion (trigger) 12b to 100 mm rearward when viewed in the axial direction of the reel seat main body, and a first portion 23 occupying at least 10° of the upper half portion of the grip portion 21 has (or is configured to have) a flat surface (the first portion 23 has a flat surface in the illustrated example) or a curved surface whose curvature radius is larger than that of the rest of the portion (a second portion) 24 other than the first portion 23 when viewed in a circumferential direction of the reel seat main body. Here, the wording “frontward of the bulging portion (trigger) 12b” refers to the direction on the side on which the above-described rod body is attached, and “rearward of the bulging portion (trigger) 12b” refers to the direction on the side of the above-described grip 4.

According to the fishing rod handle member 20 of one embodiment of the present disclosure, it is possible to significantly improve the grip property during gripping of the reel seat main body while individually forming the reel seat main body and the grip constituting the handle member into desired shapes. It has been found that arranging a surface formed in a straight line or a curved surface close to a straight line for a portion with which the fingertip is in contact when the grip portion is gripped, as described above, causes the surface to function as an anti-rotation in a rotation direction with the axial length of the grip portion as the rotation center, leading to the significant improvement in the grip property. Here, assuming that the grip portion of the fishing rod is gripped by an angler to grip the fishing rod, a proportion required for exerting the anti-rotation effect on the finger has been considered using an assumed outside diameter of the grip portion (for example, φ20 to 27 mm, but not limited thereto) and width of an angler's finger (10 to 19 mm) and, as a result, it has been found that the anti-rotation effect is favorable when the angle of the upper half portion of the grip portion 21 is at least 10° or more when viewed in the circumferential direction. In addition, it has been found that the anti-rotation effect is more favorable when the angle is 30° or more at the central portion of the grip portion with which the finger is in contact (the central portion of the grip portion with which the finger is in contact in the axial direction, for example, a portion from 30 mm frontward of the bulging portion 12b to 80 mm rearward).

The fishing rod handle member 20 according to one embodiment of the present disclosure is configured such that the curvature radius of the curved surface of the first portion 23 (a pair of (two pieces of) the first portions 23 are formed in the example illustrated in FIG. 4B) occupying at least 10° of the upper half portion of the grip portion 21 is R20 or more or −R30 or less. The number of the first portions 23 may be two as illustrated in FIG. 4B, or may be one or three or more (the same applies throughout the present specification). With this configuration, a transition portion between the first portion and the second portion can exert the anti-rotation effect on the fingertip and an area near the first joint when the fishing rod handle is gripped, thus making it possible to significantly improve the grip property. In addition, the fishing rod handle member according to one embodiment of the present disclosure is configured such that the curvature radius of the second portion 24 (the lower half portion illustrated in FIG. 4B) is R13 or more and less than R20.

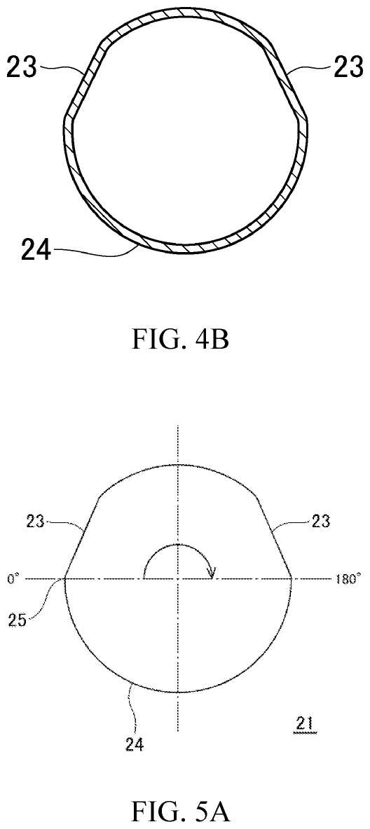

The fishing rod handle member according to one embodiment of the present disclosure is configured so as to include the transition portion between the first portion on the upper half portion of the grip portion and the second portion. In addition, in the fishing rod handle member according to one embodiment of the present disclosure, the transition portion is a line (an inflection line (not illustrated)) or a surface (an inflection surface (a cross section of an inflection surface 25 illustrated in FIG. 5 described later)), and when the transition portion is the inflection surface, the surface is flat or has a curvature radius in a range of R0.1 to R1.0. Thus, the transition portion functions to get into (fit into) the finger joint and can exert an anti-rotation effect, making it possible to significantly improve the grip property.

In the fishing rod handle member according to one embodiment of the present disclosure, the grip includes the grip portion in a range (Y) of 100 mm from the rear end when viewed in the axial direction, and the first portion occupying at least 10° of the upper half portion of the grip portion has (or is configured to have) a flat surface or a curved surface whose curvature radius is larger than that of the rest of the portion (the second portion) other than the first portion when viewed in the circumferential direction of the grip.

According to the fishing rod handle member 20 of one embodiment of the present disclosure, it is possible to significantly improve the grip property during gripping of the reel seat main body while individually forming the reel seat main body and the grip constituting the handle member into desired shapes. It has been found that arranging a surface formed in a straight line or a curved surface close to a straight line for a portion with which the fingertip is in contact when the grip is gripped, as described above, causes the surface to function as an anti-rotation in a rotation direction with the axial length of the grip as the rotation center, leading to the significant improvement in the grip property. Here, assuming that the grip of the fishing rod is gripped by an angler to grip the fishing rod, a proportion required for exerting the anti-rotation effect on the finger has been considered using an assumed outside diameter of the grip (for example, φ20 to 27 mm, but not limited thereto) and width of an angler's finger (10 to 19 mm) and, as a result, it has been found that the anti-rotation effect is favorable when the angle of the upper half portion of the grip portion 21 is at least 10° or more when viewed in the circumferential direction. In addition, it has been found that the anti-rotation effect is more favorable when the angle is 30° or more at the portion of the grip with which the finger is in contact (for example, a portion of the grip in a range of 0 mm to 80 mm from the rear end in the axial direction).

The fishing rod according to one embodiment of the present disclosure includes the fishing rod handle member according to one embodiment of the present disclosure and the rod body.

According to the fishing rod of one embodiment of the present disclosure, it is possible to significantly improve the grip property during gripping of the reel seat main body while individually forming the reel seat main body and the grip constituting the handle member into desired shapes. It has been found that arranging a surface formed in a straight line or a curved surface close to a straight line for a portion with which the fingertip is in contact when the grip is gripped, as described above, causes the surface to function as an anti-rotation in a rotation direction with the axial length of the grip as the rotation center, leading to the significant improvement in the grip property.

Next, the grip portion 21 of the fishing rod handle member 20 according to one embodiment of the present disclosure will be described using a cross-sectional view (A-A cross section in FIG. 4A) with reference to FIGS. 5A and 5B, 6, and 7 (the hollow portion is omitted for convenience of description). Description will be given below taking the grip portion 21 of the reel seat main body 20 as an example although the same applies to the grip portion of the grip 4. Here, the position of the first portion in the axial direction of the fishing rod handle member 20 according to one embodiment of the present disclosure is not limited to the position of the A-A cross section in FIG. 4A, and can be the described position. In addition, the circumferential position (of the cross section) at which the first portion is formed in the fishing rod handle member 20 according to one embodiment of the present disclosure may be the same regardless of the position in the axial direction of the grip portion 21 or may be different according to the position.

First, FIG. 5A illustrates an example of the cross-sectional view of the grip portion 21 of the fishing rod handle member 20, and FIG. 5B illustrates an enlarged view. As illustrated in the drawing, in the fishing rod handle member 20 according to one embodiment of the present disclosure, the first portion 23 indicating at least 10° (angle α in the circumferential direction) of the upper half portion of the grip portion 21 (a pair (two pieces) of the first portions 23 are formed in the example illustrated in FIG. 5A) has (or is configured to have) a flat surface (the first portion 23 is a flat surface in the example of FIG. 5A) or a curved surface whose curvature radius is larger than that of the rest of the portion (the second portion) 24 other than the first portion when viewed in the circumferential direction of the reel seat main body. The angle in the circumferential direction (of the cross section) occupied by the first portion (angle occupied in the upper half portion) in the fishing rod handle member 20 according to one embodiment of the present disclosure may be the same regardless of the position in the axial direction of the grip portion 21 or may be different according to the position. As described above, assuming that the grip of the fishing rod is gripped by an angler to grip the fishing rod, a proportion required for exerting the anti-rotation effect on the finger has been considered using an assumed outside diameter of the grip (for example, φ20 to 27 mm, but not limited thereto) and width of an angler's finger (10 to 19 mm) and, as a result, the angle of the upper half portion of the grip portion 21 can be at least 10° when viewed in the circumferential direction, and the angle at the central portion of the grip portion with which the finger is in contact (the central portion of the grip portion with which the finger is in contact in the axial direction, for example, a portion from 30 mm frontward of the bulging portion 12b to 80 mm rearward) can be 30° or more.

FIG. 5B illustrates three profiles of the flat surface of FIG. 5A (A illustrated in FIG. 5B), B having a curvature radius of R20, and C having a curvature radius of −R30. It should be understood that the above-mentioned phrase “curvature radius is larger” means that the absolute value of the numerical value is large.

The first portion 23 illustrated in FIG. 5B is one example and the curvature radius of the curved surface of the first portion 23 occupying at least 10° of the upper half portion of the grip portion 21 (a pair of (two pieces of) the first portions 23 are formed in the example illustrated in FIG. 5B) can be configured to be R20 or more or −R30 or less. In addition, the first portion 23 of the grip portion 21 can be formed over a range of 5 degree to 45 degree angles in the circumferential direction of the upper half portion (an angle of 40 degrees (angle α) in the example illustrated in FIG. 5A). The angle may vary depending on the number of the first portions 23 provided in the grip portion 21. In addition, an inflection line (an inflection point in a cross section) or an inflection surface (a curve in a cross section) is formed as the transition portion between the first portion 23 and the second portion 24, and a curvature radius of the transition portion (the inflection surface) is set in a range of R0.1 to R1.0. In the example illustrated in FIGS. 5A and 5B, the inflection surface 25 is formed, and the curvature radius of the inflection is set in a range of R0.1 to R1.0. With this configuration, a round shape is formed instead of an edge to prevent the hand from being damaged during gripping, and the inflection surface 25 can function to fit into the hand by getting into the finger joint.

Here, the upper half portion refers to a portion of the grip portion in a range from 0° to 180° angles (when viewed in a cross section) as illustrated in FIG. 5A. The lower half portion refers to a range from 180° to 360° angles illustrated in FIG. 5A. The other portion (the rest of the portion or the second portion) 24 refers to a portion other than the first portion, but herein refers to the lower half portion for convenience. In addition, the angular range in which the first portion 23 is provided may be different depending on the axial position of the fishing rod handle member 20 or be the same. The same applies throughout the present specification.

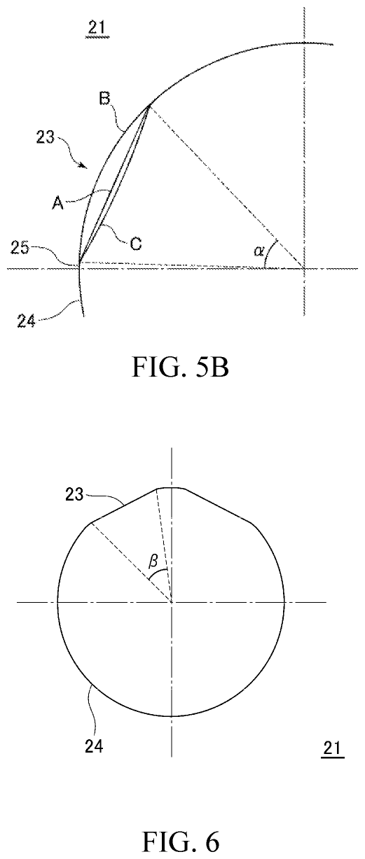

Next, FIG. 6 illustrates another example of the cross-sectional view of the grip portion 21 of the fishing rod handle member 20. As illustrated, the first portion 23 of the grip portion 21 can be formed over a range from 45 degree to 90 degree angles in the circumferential direction of the upper half portion (an angle of 40 degrees (angle β) in the example illustrated in FIG. 6). In the illustrated example, the first portion 23 is formed into a flat surface.

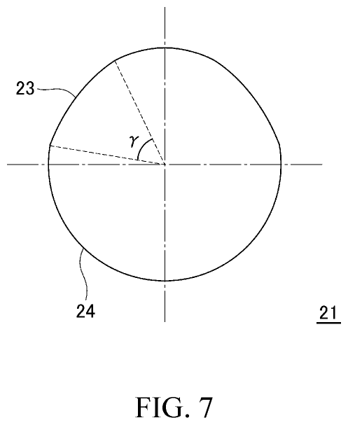

Next, FIG. 7 illustrates another example of the cross-sectional view of the grip portion 21 of the fishing rod handle member 20. As illustrated, the first portion 23 of the grip portion 21 can be formed over a range from 5 degree to 60 degree angles in the circumferential direction of the upper half portion (an angle of 55 degrees (angle γ) in the example illustrated in FIG. 7). In the illustrated example, the first portion 23 is formed into a curved surface whose curvature radius is R20 or more or −R30 or less.

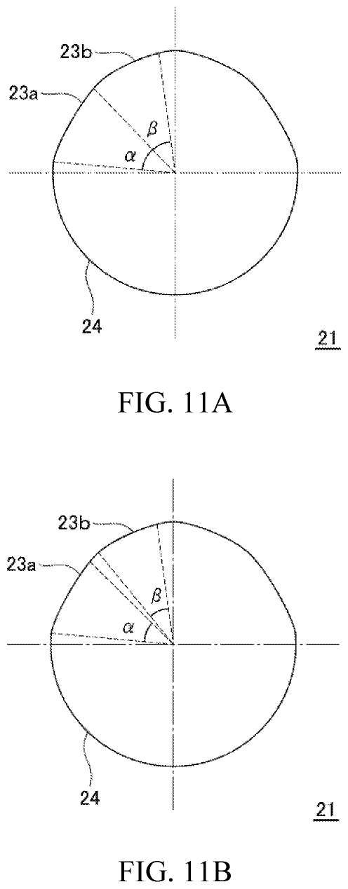

Next, FIGS. 11A and 11B illustrate another example of the cross-sectional view of the grip portion 21 of the fishing rod handle member 20. As illustrated in FIGS. 11A and 11B, the first portion 23 of the grip portion 21 includes a portion 23A formed over a range of 5 degree to 45 degree angles in the circumferential direction of the upper half portion (an angle of 40 degrees (angle α) in the example illustrated in FIGS. 11A and 11B) and a portion 23B formed over a range of 45 degree to 90 degree angles in the circumferential direction of the upper half portion (an angle of 40 degrees (angle β) in the example illustrated in FIGS. 11A and 11B) (In the illustrated example, a pair of 23A and 23B is formed on the left and right sides (that is, a total of four portions)). In this manner, two first portions 23 of the grip portion 21 are provided, and when formed as a pair, a total of four first portions are provided. Thus, it is possible to further improve the anti-rotation effect during gripping. Here, the first portion 23 of the grip portion 21 is not limited to a specific aspect, and various aspects are conceivable. In addition, in FIG. 11B, the transition portion is formed between the portions 23A and 23B, while in FIG. 11A, the portions 23A and 23B are continuously formed; thus, either of these aspects can be appropriately selected. Furthermore, when three first portions 23 are provided (although not illustrated, for example, 23A, 23B, and 23C), the configuration can be such that the transition portion is formed between 23A and 23B while 23B and 23C are continuously formed.

As illustrated in FIGS. 4A and 4B, the fishing rod handle member 20 according to one embodiment of the present disclosure is configured such that an end of the rod body is attached to one end 15 of the reel seat main body 12 on the opposite side of the grip 4. With this configuration, unlike many conventional methods, it is not necessary to pass the rod body through the entire or substantially the entire fishing rod handle member 20, making it possible to significantly reduce the weight.

In the fishing rod handle member 20 according to one embodiment of the present disclosure, the length (A) of the end 15 of the reel seat main body 12 is configured to be 20-50 mm. With this configuration, as described above, it is not necessary to pass the rod body through the entire or substantially the entire fishing rod handle member 20, making it possible to significantly reduce the weight. Here, the method for attaching the end of the rod body to the fishing rod handle member 20 can be, for example, fitting (press-fitting), bonding, or fastening, but is not limited thereto. The attachment method described above has an advantage that the rod body and the handle member are easily attached or detached.

In the fishing rod handle member 20 according to one embodiment of the present disclosure, the fishing rod handle member is formed in a hollow shape, but a circumferential rib may be provided in a region where the end of the rod body is attached to one end 15 of the reel seat main body 12 on the opposite side of the grip 4. With this configuration, it is possible to significantly reduce the weight without affecting the sensitivity given to the fishing rod and to enhance the rigidity in the circumferential direction (crushing rigidity).

In the fishing rod handle member 20 according to one embodiment of the present disclosure, an inner layer (not illustrated) may be provided inside the fishing rod handle member 20. In this case, a resin material can be used as the inner layer. With this configuration, it is possible to form a fishing rod handle member including the reel seat that has high processability on the inner surface and is less likely to cause absence of resin and fiber fuzz on the inner surface. More specifically, since the inner layer is present inside the fishing rod handle member 20, resin necessary for fibers can be supplied, so that physical properties can be stabilized (the lower limit of strength can be guaranteed). In addition, when a component is inserted into or bonded to the inner layer, it may be necessary to perform additional processing of the inner diameter according to the dimension of a component, but there is a problem that a processing allowance cannot be secured if the inner side is fuzzy; however, since the processing allowance can be sufficiently secured due to the presence of the inner layer, it is possible to mold a handle member having a more flexible and stronger structure.

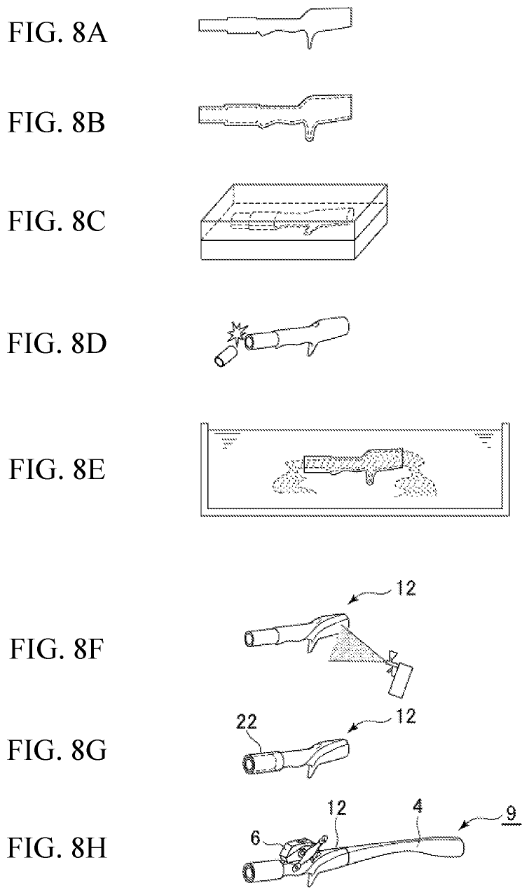

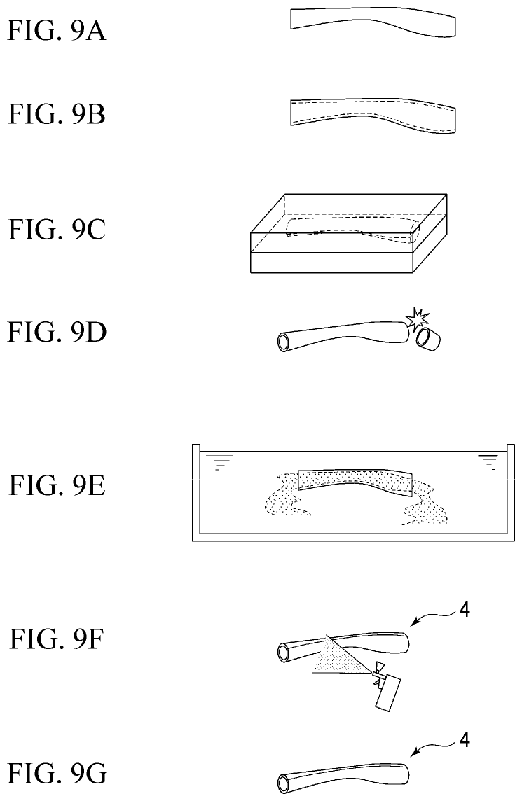

Next, a method of molding the reel seat main body 12 and the grip 4 of the fishing rod handle member 20 according to one embodiment of the present disclosure (when carbon fiber reinforced plastic (CFRP) is used) will be described with reference to FIGS. 8A to 8H and 9A to 9G. First, as illustrated in FIG. 8A, the dimensions and shape of a core member are determined in accordance with the shape and the dimensions of the reel seat main body 12 of the fishing rod handle member 20 (for example, such that the core member is offset inward from the reel seat main body 12 by about 0.5-1 mm) and a soluble core member is formed (formation of the core member). Examples of the method for forming the core member include injection molding, cast molding, and formation by a 3D printer, but are not limited thereto. The surface layer of the core member is covered with an insoluble resin.

Next, as illustrated in FIG. 8B, a prepreg is laminated around the core member to form a preform. Here, as a material to be laminated, a dry carbon fiber base material not impregnated with resin may be used. Then, as illustrated in FIG. 8C, the preform is placed in a mold and heated and pressurized for press molding. Autoclaving, RTM, or the like may be alternatively used, but the process is not limited to specific aspects.

Next, as shown in FIG. 8D, secondary processing (dimensioning and deburring) is performed on the molded product. More specifically, extra portions such as a front or rear portion of the molded product and burrs generated during molding are removed. Next, as illustrated in FIG. 8E, the molded product subjected to the secondary processing is put in water, warm water, or the like to dissolve the core member inside the molded product. Thus, the reel seat main body 12 is formed. Then, as illustrated in FIG. 8F, coating or printing is appropriately performed on the outer surface of the reel seat main body 12. Then, as illustrated in FIG. 8G, components and the like for mounting the reel are attached. Finally, as illustrated in FIG. 8H, the reel can be placed and fixed on the reel seat main body 12.

Next, as illustrated in FIG. 9A, the dimensions and shape of a core member are determined in accordance with the shape and the dimensions of the grip 4 of the fishing rod handle member 20 (for example, such that the core member is offset inward from the grip 4 by about 0.5-1 mm) and a soluble core member is formed (formation of the core member). Examples of the method for forming the core member include injection molding, cast molding, and formation by a 3D printer, but are not limited thereto. The surface layer of the core member is covered with an insoluble resin.

Next, as illustrated in FIG. 9B, a prepreg is laminated around the core member to form a preform. Here, as a material to be laminated, a dry carbon fiber base material not impregnated with resin may be used.

Then, as illustrated in FIG. 9C, the preform is placed in a mold and heated and pressurized for press molding. Autoclaving, RTM, or the like may be alternatively used, but the process is not limited to specific aspects.

Next, as shown in FIG. 9D, secondary processing (dimensioning and deburring) is performed on the molded product. More specifically, extra portions such as a front or rear portion of the molded product and burrs generated during molding are removed.

Next, as illustrated in FIG. 9E, the molded product subjected to the secondary processing is put in water, warm water, or the like to dissolve the core member inside the molded product. Thus, the grip 4 is formed. Thereafter, as illustrated in FIG. 9F, coating or printing is appropriately performed on the outer surface of the fishing rod handle member 20. Then, the fishing rod handle member 20 according to one embodiment of the present disclosure can be formed by connecting the similarly molded grip to the reel seat main body molded as described above.

Thus, the fishing rod handle member 20 according to one embodiment of the present disclosure, that is, the fishing rod handle member 20 including the reel seat main body 12 having the grip portion and the reel leg placement portion 12a on which the reel leg 6b is placed, and the grip 4 connected to the reel seat main body 12 is formed.

According to the fishing rod handle member 20 of one embodiment of the present disclosure formed as described above, it is possible to significantly improve the grip property during gripping of the reel seat main body while individually forming the reel seat main body and the grip constituting the handle member into desired shapes.

Next, another method of molding the fishing rod handle member 20 according to one embodiment of the present disclosure will be described. First, the dimensions and shape of a core member are determined in accordance with the shape and the dimensions of the reel seat main body or grip of the fishing rod handle member 20 (for example, such that the core member is offset inward from the reel seat main body or grip by about 0.5-1 mm) (designing of the core member). Water soluble sand is used to form a sand mold core member in accordance with the dimensions and shape of the core member.

Next, a preform is formed around the core member using carbon not impregnated with resin. Specifically, cloth materials (woven fabrics), non-crimped fabrics (NCF), braids, and a UD tape can be used, but the material is not limited thereto. In addition, it is necessary to shape carbon fibers around the core member, and at that time, a binder is used to impart tackiness. Examples of the binder include, but are not limited to, epoxy-based, rosin-based, polyamide, polyphenylene sulfide, polyetherimide, polyethersulfone, polysulfone, polyphenylene ether, polyimide, polyamideimide, and phenoxy. Here, in the above example, description has been given about the case of using carbon not impregnated with resin, but it is also acceptable to use a method in which a prepreg including carbon cloth or the like impregnated with resin is laminated and arranged directly around the core by hand lay-up or the like and the prepreg is molded (cured). The preform is set in a mold, and resin is injected (RTM method). Then, the core member of the sand mold is removed in water. Finally, deburring, polishing, coating, and the like are performed on the molded product to form the reel seat main body and the grip.

Such an RTM method is a manufacturing method in which a low-viscosity resin is poured in, and provides the advantage that it is possible to avoid a portion not impregnated with resin such as absence of resin and void as much as possible even in a complicated shape such as the reel seat main body or the grip. In addition, since a material having better shapability than a prepreg can be used, shaping can be performed without unnecessarily applying a load to the fibers even in molding of a complicated shape. Furthermore, since the outer side is formed by the mold and the inner side is formed by the core material, there is an advantage that both the outer side and the inner side can be molded with desired dimensions and the molded product has a good surface state on both sides. Therefore, the RTM method makes it possible to stabilize quality and avoid insufficient strength.

Next, another method of molding the fishing rod handle member 20 according to one embodiment of the present disclosure will be briefly described. First, a mold molded according to the shape and dimensions of the reel seat main body and the grip is prepared. A prepreg is placed in the mold as a preform, and pressed against an outer die in the mold due to pneumatic force (internal pressure molding) to form a molded product. Then, deburring, polishing, coating, and the like are performed on the molded product to form the reel seat main body and the grip. In such an internal pressure molding method, the prepreg is pressed against the mold (outer die) under the internal pressure for molding, so that the outer surface of the molded product can be more favorably molded. In addition, since using the prepreg enables fabrication of a molded product having a relatively small amount of resin, the weight of the product can be reduced.

The dimensions, material, and arrangement of each component described herein are not limited to those explicitly described in the embodiments, and each component may be modified to have any dimensions, material, and arrangement that may fall within the scope of the present disclosure. In addition, components not explicitly described herein can be added to the described embodiments, or some of the components described in each embodiment can be omitted.

What is claimed is:

1. A fishing rod handle member comprising: a reel seat main body having a bulging portion (trigger) and a reel leg placement portion on which a reel leg is placed; and a grip provided rearward of the reel seat main body when viewed in an axial direction of the reel seat main body,
wherein the reel seat main body has a grip portion in a range from 40 mm frontward of the bulging portion (trigger) to 100 mm rearward when viewed in the axial direction, and a first portion occupying at least 10° of an upper half portion of the grip portion is a flat surface or a curved surface whose curvature radius is larger than that of a rest of the portion (a second portion) other than the first portion when viewed in a circumferential direction of the reel seat main body.

2. The fishing rod handle member according to claim 1, wherein the reel seat main body and the grip are formed separately.

3. The fishing rod handle member according to claim 1, wherein at least one of the reel seat main body and the grip is partially or entirely formed of carbon fiber reinforced plastic.

4. The fishing rod handle member according to claim 1, wherein a curvature radius of a curved surface of the first portion occupying at least 10° of the upper half portion of the grip portion is R20 or more or −R30 or less.

5. The fishing rod handle member according to claim 1, wherein a curvature radius of a curved surface of the second portion other than the first portion is R13 or more and less than R20.

6. The fishing rod handle member according to claim 1, comprising a transition portion between the first portion of the upper half portion of the grip portion and the rest of the portion (the second portion) other than the first portion.

7. The fishing rod handle member according to claim 6, wherein the transition portion is an inflection line or an inflection surface, and when the transition portion is the inflection surface, the surface is flat or has a curvature radius in a range of R0.1 to R1.0.

8. The fishing rod handle member according to claim 1, wherein the grip includes a grip portion in a range of 100 mm from a rear end when viewed in the axial direction, and a first portion occupying at least 10° of an upper half portion of the grip portion is a flat surface or a curved surface whose curvature radius is larger than that of the rest of the portion (the second portion) other than the first portion when viewed in the circumferential direction of the grip.

9. The fishing rod handle member according to claim 1, wherein the fishing rod handle is formed in a hollow shape.

10. The fishing rod handle member according to claim 1, wherein an end of a rod body is attached to one end of the reel seat main body on an opposite side of the grip.

11. A fishing rod comprising: the fishing rod handle member according to claim 1; and a rod body.
